(19) United States
(12) Patent Application Publication
(10) Pub. No.: US 2017/0295277 A1
(43) Pub. Date: Oct. 12, 2017

(54) Cell phone for prevention of accidents

(71) Applicant: Freddie Lee Figgers, Florida, FL (US)

(72) Inventor: Freddie Lee Figgers, Florida, FL (US)

(21) Appl. No.: 15/632,496

(22) Filed: Jun. 26, 2017

(51) Int. Cl. H04M 1/725

(52) U.S. Cl. CPC H04M 1/72577; H04M 1/72569; H04M 2250/10; H04M 1/72552

(57) ABSTRACT

A cell phone which can be used to disable texting, calling and other features while driving a moving vehicle. The position and speed of a user's cell phone are captured with the help of global positioning system feature present in the cell phone. If the speed match that of the threshold speed, then the cell phone will be automatically set to airplane mode where the cell phone blocks the texting, calling and other features. The cell phone enables incoming of texts and also reads them but blocks the outgoing of calls and texts. The cell phone also has a system where it only blocks the user in the driver's seat and not the fellow passengers.

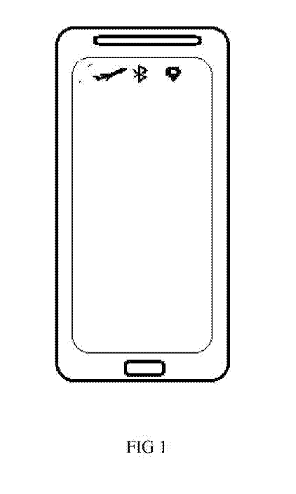

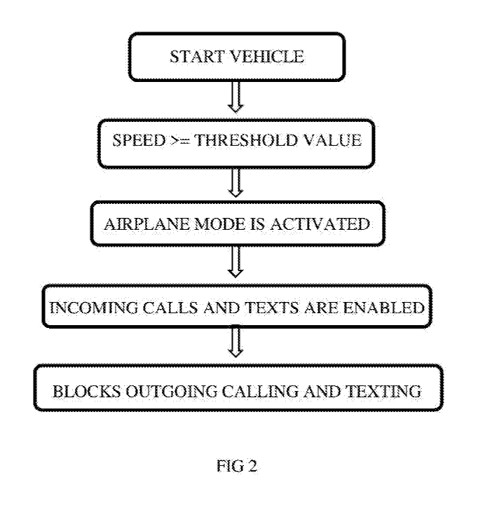

### BACKGROUND OF THE INVENTION

The present invention is in the technical field of electronic gadgets. More particularly, the present invention is in the technical field of cellular phone with wireless communication.

### SUMMARY OF THE INVENTION

The present invention is a cellular phone which detects the motion and prevents simultaneous texting and driving.

The preferred embodiment of the present invention comprises of a cellular phone that detects and blocks simultaneous texting and driving, or texting while the phone user is seated in the driver's seat while the vehicle is moving.

Some embodiment of the present invention blocks the occurrences of texting, mailing, browsing the internet, using the cellular phone for taking pictures, videos and do other things while driving, or while seating in a driver's seat of a moving vehicle.

The preferred embodiment of the present invention comprises of a direct GPS motion detection mechanism which is common to a standard US/Canadian full size sedan. The system uses virtual boundary alert mechanism along with the GPS, which give an alert in the form of a ping that specifies the location of the user. This exactly shows where the user is located in the moving vehicle. If the user is located on the left side of the vehicle, then the application enables the detection from the left side of the vehicle.

The cellular phone determines the speed of the vehicle and when the phone is in motion and it is detected on the left side (USA/Canada) when the motion of the phone exceeds more than 10 miles per hour.

When the speed exceeds 10 miles per hour, the cellular phone automatically switches to airplane mode and blocks SMS and data services. The cellular phone in airplane mode, cannot send any messages from it while there is an additional feature where the user can receive calls, messages, data transmissions which will be read out loud by the phone itself preventing the user from touching the phone. The user gets an option where he can automatically reply to the caller.

### DETAILED DESCRIPTION OF THE INVENTION

The present invention comprises of a cellular phone with wireless communication wherein the cellular phone automatically prevents simultaneous texting and driving.

In the following detailed description, many details are set forth in order to provide a thorough understanding of some embodiments. However, it will be understood by persons of ordinary skill in the art that some embodiments may be practiced without these specific details.

The cellular phone mentioned above is a smartphone which is used to end and/or receive phone calls, a device able to send and/or receive text messages and/or SMS messages and/or MMS messages and/or Instant Messages.

The preferred embodiment of the present invention includes, a smartphone which prevents its user from performing one or more operations via the phone, while the user is seated in a vehicular driver seat; or, while the user is seated in a driver seat of a moving vehicle.

Global positioning system or GPS is one such feature in the cell phone which can be used in determining the speed of the vehicle in which the user is travelling. Using GPS feature, the cell phone detects location of the cell phone periodically and it calculates the speed at which the user is moving. If the speed exceeds 10 miles per hour, then the cell phone automatically blocks the SMS and data by setting the cellular phone to airplane mode.

The invention may not suffice to merely estimate that a phone is located within a moving vehicle, in order to block one or more features of the phone like texting or emailing as this approach may often result in a blocking other passengers who are travelling in the same vehicle. The challenge for such invention would be to stop the driver of the vehicle from using the cellular phone.

The other passengers may also be incorrectly blocked or prevented from using such features in the passenger's phone, even though the passenger is not driving or operating the vehicle.

To eliminate such instances and in order to provide an effective solution that prevents, reduces or eliminates the unsafe or illegal practice of texting while driving, it may be beneficial and advantageous to determine whether or not the phone is utilized by a driver or by a passenger in a moving vehicle.

The phone can automatically determine whether or not the phone user is within a vehicle and whether or not the phone user is seated in a driver seat of a vehicle. In order to achieve this, OPS feature is provided in the cell phone with which the cellular phone may determine one or more of the driver-seat related determinations automatically.

The preferred embodiment of the present invention comprises of a direct GPS Motion detection which is common for a standard US/Canadian full size sedan. This system uses virtual boundary alert along with GPS, which gives a ping which is a form of notification which allows the phone to detect the location of the user.

If the user of the cell phone is present on the left side of the vehicle, then the cell phone enables the application for the left side detection and if the user is located on the right side of the vehicle, then the cell phone enables the application for the right side detection.

These features of the present invention makes it more robust and efficient, and the present invention can be used in any suitable vehicle, without the need to modify or configure the vehicle or any component of the vehicle.

The risks of using a cellular phone which driving, though real, are not large enough to be detected in overall crash/fatality statistics but are potentially large enough to be a legitimate concern of motorists and policymakers.

Motor vehicle collisions are harmful in many ways. For motorists these collisions can result in minor, serious, crippling, and even fatal injuries. Collisions result in property damage to vehicles that is often expensive to repair. There are also related health care costs, litigation expenses, insurance administration, lost work time, and other adverse ramifications of collisions.

In urban areas, each collision occurring in rush hour can induce a cascade of traffic congestion, emergency response time, and grief for those affected. Thus, if use of cellular phones while driving causes more collisions, motorists and policymakers should be concerned. Businesses and insurers may also become concerned since these firms bear a significant fraction of the monetary costs of motor vehicle collisions.

The use of a cellular phone while driving may entail a variety of different maneuvers: searching for a phone in the vehicle, reaching for a phone to initiate or receive a call, dialing, holding a phone near the ear while talking and driving, picking up a phone that has been dropped, and so forth. The various tasks entailed in using a cellular phone each require a different amount of time, mental energy, and coordination, leading to potentially different complications of the driving task and resulting risk of collision.

There are two types of risks associated with using cellular phone while driving. They include the risk of fatality to the user of the cellular phone, which we compared to other voluntary risks that drivers accept and the risk of cellular phone use to other road users (occupants of other vehicles, pedestrians, bicyclists), which we compare to other involuntary risks in daily life.

Use of the present invention helps to overcome the above mentioned disadvantages of using cellular phone while driving, as it automatically blocks the use of cellphone, hence avoiding the accidents as well.

I claim:

1. An cell phone system which disables the texting and calling activities from the cell phones of the user comprising of features like GPS, mobile phone signal receiver, cell phone tower and GPS satellite.

2. The cell phone as claimed in claim 1, comprises of GPS sensor which detects the speed and location of the driver with the help of GPS satellite.

3. The cell phone as claimed in claim 1, wherein the system uses virtual boundary alert along with GPS, which gives a ping which is a form of notification, allows the phone to detect the location of the user.

4. The cell phone as claimed in claim 1, wherein the cell phone activates the airplane mode once the threshold speed is reached.

5. The cell phone as claimed in claim 3, wherein the airplane mode disables the inbuilt features of calling or receiving calls while driving.

6. The cell phone as claimed in claim 3, wherein the airplane mode disables the inbuilt features of texting while driving.

7. The cell phone as claimed in claim 3, wherein the airplane mode allows the texts to be received and read out loud by the cell phone.

8. The cell phone as claimed in claim 1, wherein the cell phone tower can be used to identify the cell phone of driver or passenger.

9. The cell phone as claimed in claim 1, wherein the driver-seat determinations are done using GPS feature of the cell phone.
